(19) United States
(12) Patent Application Publication
(10) Pub. No.: US 2023/0371732 A1
(43) Pub. Date: Nov. 23, 2023

(54) FILTRATION CONTAINER ASSEMBLY AND EXTRACTION ASSEMBLY FOR SAME

(71) Applicant: GRAYL INC., Seattle, WA (US)

(72) Inventors: Travis Merrigan, Bremerton, WA (US); Patrick Crosby, Terrell, NC (US); Scott Rolfson, Portland, OR (US); Cheng Kuo Lin, Tainan City (TW); Kai Chuan Chuang, Tainan City (TW)

(21) Appl. No.: 18/198,654

(22) Filed: May 17, 2023

Related U.S. Application Data
(60) Provisional application No. 63/343,043, filed on May 17, 2022.

(51) Int. Cl. A47J 31/06; A47J 31/00; A47J 31/38; A47J 31/36

(52) U.S. Cl. CPC A47J 31/0626; A47J 31/005; A47J 31/38; A47J 31/3671; B65D 47/142

(57) ABSTRACT

A container assembly in accordance with one embodiment of the present disclosure includes an outer container having a first open end and a second closed end and defining an inner cavity; and a plunging assembly configured to be received within the outer container, the plunging assembly having a first end and a second end, wherein the plunging assembly includes an inner sleeve having a first end and a second end and a wall defining an inner bore, and wherein the plunging assembly includes an extraction assembly having a body having a first end and a second end and a side wall extending for at least a portion of the distance between the first and second ends of the body, wherein the first end of the body is coupled to the inner sleeve at or near the second end of the inner sleeve, and wherein the body includes a first sieve portion, and wherein the extraction assembly further includes a strainer having a second sieve portion, wherein the strainer is removably couplable to the body.

### CROSS-REFERENCE TO RELATED APPLICATION

This application claims the benefit of U.S. Provisional Application No. 63/343,043, filed May 17, 2022, entitled “FILTRATION CONTAINER ASSEMBLY AND EXTRACTION ASSEMBLY FOR SAME”, the disclosure of which is expressly incorporated by reference herein in its entirety.

### BACKGROUND

Positive pressure coffee and tea presses having a single container generally include a plunger received in an outer container. The plunger typically includes a screen filter mounted at the end of a shaft. Hot water is mixed with coffee grounds in the container, and the shaft is pressed down by the user into the container. As the shaft is pressed down, the screen filter presses the coffee grounds to the bottom of the container, while allowing the filtered coffee to pass through the screen to the top of the container. Depending on the tightness of the fit of the screen filter in the container, some grounds may pass to the filtered coffee around the outer perimeter of the screen filter, resulting in undesirable coffee grounds in the user's coffee. Because of the likeliness of contamination in the filtered coffee, a “coffee-press” type water filter is not a good design for water filtration.

Therefore, there exists a need for an improved positive-pressure filter assembly that can improve the experience for a user in filtering water, coffee, and other liquids. There also exists a need for other improvements in container assemblies, such as improved cap assemblies.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one embodiment of the present disclosure, a container assembly is provided. The container assembly includes: an outer container having a first open end and a second closed end and defining an inner cavity; and a plunging assembly configured to be received within the outer container, the plunging assembly having a first end and a second end, wherein the plunging assembly includes an inner sleeve having a first end and a second end and a wall defining an inner bore, and wherein the plunging assembly includes an extraction assembly having a body having a first end and a second end and a side wall extending for at least a portion of the distance between the first and second ends of the body, wherein the first end of the body is coupled to the inner sleeve at or near the second end of the inner sleeve, and wherein the body includes a first sieve portion, and wherein the extraction assembly further includes a strainer having a second sieve portion, wherein the strainer is removably couplable to the body.

In another embodiment of the present disclosure, an extraction assembly for a container assembly is provided. The container assembly can include: an outer container having a first open end and a second closed end and defining an inner cavity, and a plunging assembly configured to be received within the outer container, the plunging assembly having a first end and a second end, wherein the plunging assembly includes an inner sleeve having a first end and a second end and a wall defining an inner bore. The extraction assembly can include: a body having a first end and a second end and a side wall extending for at least a portion of the distance between the first and second ends of the body, wherein the first end of the body is coupled to the inner sleeve at or near the second end of the inner sleeve, and wherein the body includes a first sieve portion; and a strainer having a second sieve portion, wherein the strainer is removably couplable to the body.

In another embodiment of the present disclosure, a method of infusing a liquid using a container assembly is provided. The method can include: obtaining a filtration container assembly including an outer container having a first open end and a second closed end and defining an inner cavity and a plunging assembly configured to be received within the outer container, the plunging assembly having a first end and a second end, wherein the plunging assembly includes an inner sleeve having a first end and a second end and a wall defining an inner bore, and wherein the plunging assembly includes an extraction assembly having a body having a first end and a second end and a side wall extending for at least a portion of the distance between the first and second ends of the body, wherein the first end of the body is coupled to the inner sleeve at or near the second end of the inner sleeve, and wherein the body includes a first sieve portion, and wherein the extraction assembly further includes a strainer having a second sieve portion, wherein the strainer is removably couplable to the body; filling the outer container with a liquid to equal to or less than a fill indicator; filling the extraction assembly with an extraction substrate; coupling the extraction assembly to the inner sleeve to define the extraction plunging assembly; inserting the second end of the extraction plunging assembly into the first open end of the outer container; and pressing the extraction plunging assembly into the inner cavity of the outer container to produce a liquid extraction.

In any of the embodiments described herein, the body may include first and second body portions.

In any of the embodiments described herein, the first and second body portions may be removably couplable to one another.

In any of the embodiments described herein, the strainer may be fixed relative to the body when the first and second body portions are coupled to one another, and the strainer may be removable from the body when the first and second body portions are uncoupled.

In any of the embodiments described herein, the strainer may include a flange configured to be fixedly received between the first and second body portions when the first and second body portions are coupled to one another.

In any of the embodiments described herein, the first sieve portion may be disposed on the side wall of the body.

In any of the embodiments described herein, the strainer may include a first end and a second end and a side wall extending for at least a portion of the distance therebetween, wherein second sieve portion is disposed within the side wall of the strainer

In any of the embodiments described herein, the first end of the extraction assembly may be mechanically coupled to the inner sleeve at or near the second end of the inner sleeve.

In any of the embodiments described herein, the strainer may include a first end and a second end and a side wall extending for at least a portion of the distance therebetween, and the second sieve portion may be disposed within the side wall of the strainer

In any of the embodiments described herein, the first end of the extraction assembly may be mechanically coupled to the inner sleeve at or near the second end of the inner sleeve

In any of the embodiments described herein, the second end of the extraction assembly may be outside the inner bore of the inner sleeve

In any of the embodiments described herein, the container assembly further may include a device for releasing pressure from the inner cavity of the outer container when the plunging assembly is received within the inner cavity of the outer container

In any of the embodiments described herein, the plunging assembly may be configured to displace a liquid contained in the outer container from the inner cavity of the outer container to the inner bore of the inner sleeve of the plunging assembly.

In any of the embodiments described herein, the extraction assembly may be configured to include an extraction substrate

In any of the embodiments described herein, the extraction assembly may further include a lid.

In any of the embodiments described herein, the lid may be removable from the plunging assembly.

In any of the embodiments described herein, the lid may include an access port to the inner bore of the inner sleeve.

In any of the embodiments described herein, the method may include: prior to using the extraction plunging assembly, obtaining a filtration container assembly including an outer container having a first open end and a second closed end and defining an inner cavity and a plunging assembly configured to be received within the outer container, the plunging assembly having a first end and a second end, wherein the plunging assembly includes an inner sleeve having a first end and a second end and a wall defining an inner bore, and wherein the plunging assembly includes a filtration assembly having a body having a first end and a second end and a side wall extending for at least a portion of the distance between the first and second ends of the body, wherein the first end of the body is coupled to the inner sleeve at or near the second end of the inner sleeve; filling the outer container with a liquid to equal to or less than a fill indicator; coupling the filtration assembly to the inner sleeve to define the filtration plunging assembly; inserting the second end of the filtration plunging assembly into the first open end of the outer container; and pressing the filtration plunging assembly into the inner cavity of the outer container to produce a filtered liquid.

In any of the embodiments described herein, the method may include pouring the filtered liquid into the outer container.

In any of the embodiments described herein, the method may include further comprising heating the liquid in the outer container.

### BRIEF DESCRIPTION OF THE SEVERAL VIEWS OF THE DRAWINGS

The foregoing aspects and many of the attendant advantages of this disclosure will become more readily appreciated as the same become better understood by reference to the following detailed description, when taken in conjunction with the accompanying drawings. To easily identify the discussion of any particular element or act, the most significant digit or digits in a reference number refer to the figure number in which that element is first introduced.

FIG. 1A illustrates an isometric view of a filtration container assembly in accordance with one embodiment of the present disclosure.

FIG. 1B illustrates a top exploded view of the filtration container assembly of FIG. 1A.

FIG. 1C illustrates a bottom exploded view of the filtration container assembly of FIG. 1A.

FIG. 2A illustrates a top isometric view of a cap assembly of the filtration container assembly of FIG. 1A (with a handle in its extended position, but in phantom showing movement to a retracted position).

FIG. 2B illustrates an exploded view of the cap assembly of FIG. 2A.

FIG. 2C illustrates comparative top views of the cap assembly of FIG. 2A and the outer container of the filtration container assembly of FIGS. 1A-1C.

FIG. 3A-3D illustrate use of a filtration container assembly in accordance with embodiments of the present disclosure.

FIG. 4A illustrates another embodiment of a filtration container assembly.

FIG. 4B illustrates another view of the filtration container assembly of FIG. 4A.

FIG. 5A illustrates an isometric view of an extraction assembly in accordance with one embodiment of the present disclosure.

FIGS. 5B and 5C illustrate exploded views of the extraction assembly of FIG. 5A.

FIG. 5D illustrates a cross-sectional view of the extraction assembly of FIG. 5A.

FIG. 6 illustrates a cross-sectional view of an extraction assembly in accordance with another embodiment of the present disclosure.

FIG. 7A illustrates an isometric view of an extraction assembly in accordance with one embodiment of the present disclosure.

FIGS. 7B and 7C illustrate exploded views of the extraction assembly of FIG. 7A.

FIG. 7D illustrates a cross-sectional view of the extraction assembly of FIG. 7A.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, to achieve the same or substantially similar result.

In the following description, numerous specific details are set forth to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

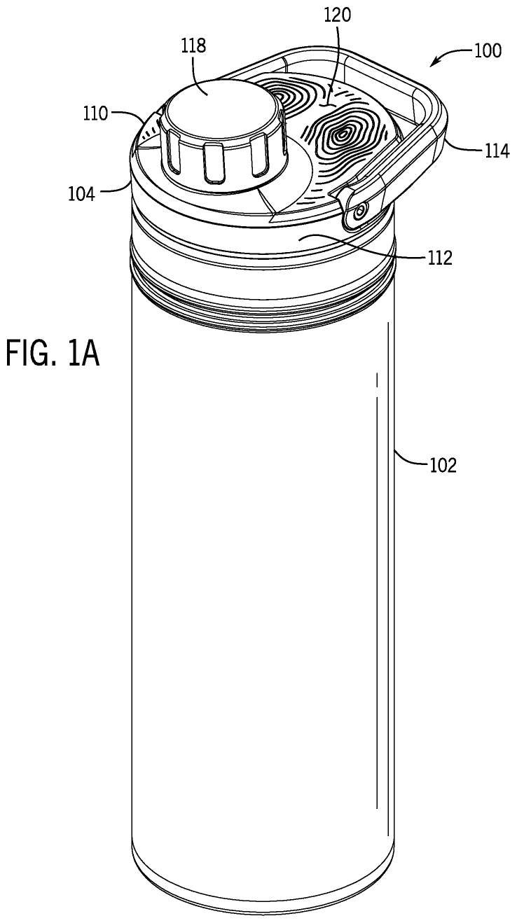

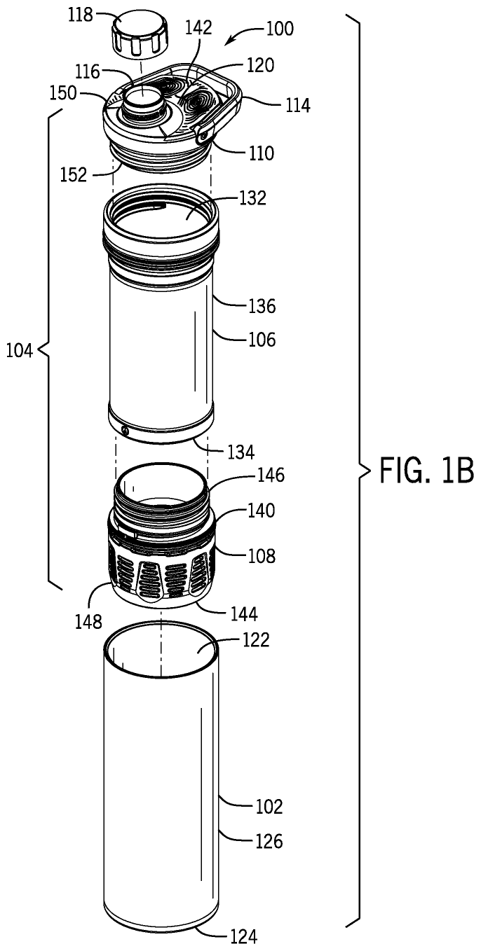

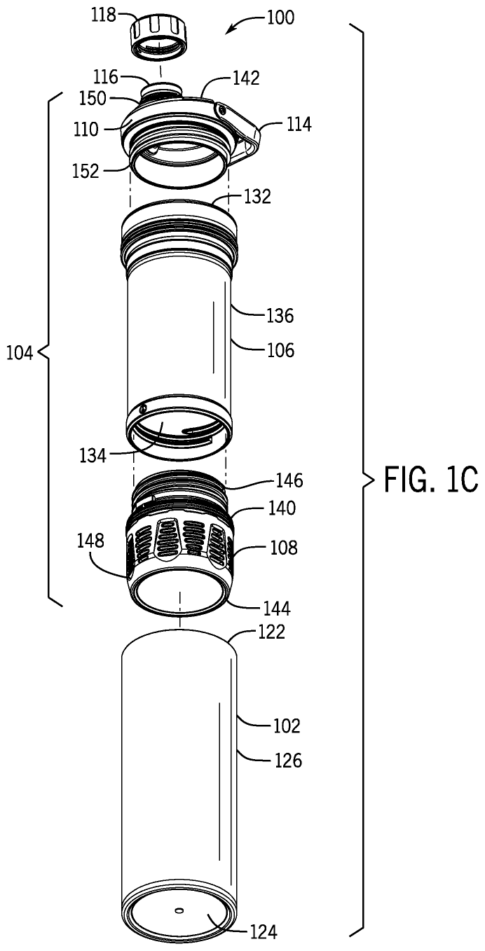

Embodiments of the present disclosure are generally directed to filtration container assemblies and methods of use therefor. In the illustrated embodiment of FIGS. 1A-IC, a filtration container assembly 100 generally includes an outer container 102 and a plunging assembly 104, which includes an inner sleeve 106 and a filtration assembly 108. The plunging assembly 104 may further include a cap assembly 110. As described in greater detail below in accordance with embodiments of the present disclosure, when the outer container 102 is at least partially filled with liquid, the user can exert pressure on the plunging assembly 104 to nest the plunging assembly 104 within the outer container 102, using positive pressure to displace the liquid in the outer container 102 through the filtration assembly 108 into the inner sleeve 106. In some embodiments, the filtration assembly 108 may be designed and configured to filter impurities from the liquid in the outer container. In other embodiments, the filtration assembly 108 may be an extraction assembly to infuse the liquid in the outer container as it passes to the inner container. Both embodiments are described in greater detail below.

Although shown and described as a personal filtration container assembly, it should be appreciated that other embodiments are within the scope of the present disclosure. For example, a filtration container assembly within the scope of the present disclosure may be configured as a large container, such as a jug, cooler, barrel, or tank, or as a smaller container, such as a bottle or sippy cup. It should be appreciated that larger form factors may use a crank or even an electric motor to achieve the positive pressure value required for filtration.

In accordance with embodiments of the present disclosure, suitable filters for use in filtration assemblies, include, but are not limited to screens, sieve fillers, granular-activated carbon filters, metallic alloy filters, microporous ceramic filters, a carbon block resin filters, electrostatic nanofiber filters, reverse osmosis filters, ion exchange filters, UV light filters, hollow fiber membrane filters, and ultra-filtration membrane filters. Suitable filters for use in the infusions assemblies, include, but are not limited to screens and sieve filters, and other suitable filters.

Any directional references in the present application, such as “up”, “down”, “top”, “bottom”, etc., are intended to describe the embodiments of the present disclosure with reference to the orientations provided in the figures and are not intended to be limiting. The term “substantially” is used herein to include standard engineering and/or manufacturing tolerances.

Referring to FIGS. 1B and 1C, the outer container 102 will now be described. In the illustrated embodiment, the outer container 102 is a substantially cylindrical cup having a wall 126 extending between a first open end 122 and a second closed end 124 and defining an inner cavity 128. Although shown in the illustrated embodiment as having a substantially cylindrical wall 126 on both inner and outer surfaces, it should be appreciated that other cross-sectional shapes are also within the scope of the present disclosure. For example, the outer container 102 may have a substantially cylindrical inner cavity 128, but a non-cylindrical outer surface. As described in greater detail below, a substantially cylindrical inner cavity 128 is designed and configured to mate with a plunging assembly 104 in accordance with one embodiment of the present disclosure.

The outer container 102 is configured to receive liquid, for example, water. In that regard, when in use, the outer container 102 may be filled or at least partially filled with liquid. The outer container 102 may be made from any suitable materials designed for holding liquid, for example, suitable plastic and/or metal materials.

Still referring to FIGS. 1B and 1C, the plunging assembly 104 will now be described. As mentioned above, the plunging assembly 104 includes the inner sleeve 106 and the filtration assembly 108, both of which are designed to be received within the inner cavity 128 of the outer container 102. In the illustrated embodiment, the inner sleeve 106 has a wall 136 extending between a first open end 132 and a second open end 134 and defining an inner bore 138 therethrough. Therefore, the inner sleeve 106 has a continuous sidewall to prevent the migration of contaminants into the filtered liquid that is stored in the inner sleeve 106.

In the illustrated embodiment, the filtration assembly 108 has a first end 146 and a second end 148, with the first end 146 of the filtration assembly 108 disposed at or near the second open end 134 of the inner sleeve 106 and the second end 148 of the filtration assembly 108 defining the second end 144 of the plunging assembly 104. The first end 146 of the filtration assembly 108 may be mechanically coupled to the inner sleeve 106 at or near the second open end 134 of the inner sleeve 106. In the illustrated embodiment, the first end 146 of the filtration assembly 108 and the second end 134 of the inner sleeve 106 include reciprocal threads for a screw interface. However, other suitable interfaces are also within the scope of the present disclosure.

In the illustrated embodiment, the filtration assembly 108 is disposed outside the inner bore 138 of the inner sleeve 106. However, in some embodiments, the filtrations assembly 108 may be all or partly disposed within the inner bore 138 of the inner sleeve 106.

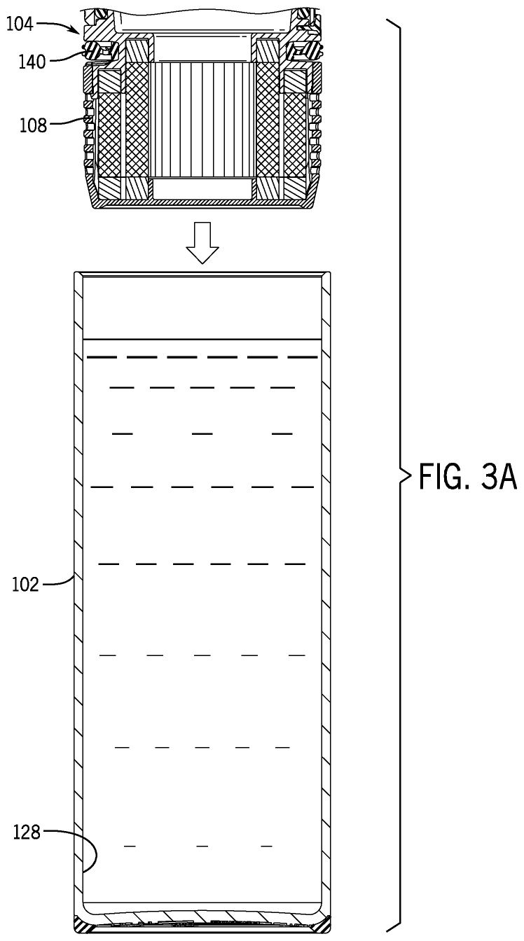

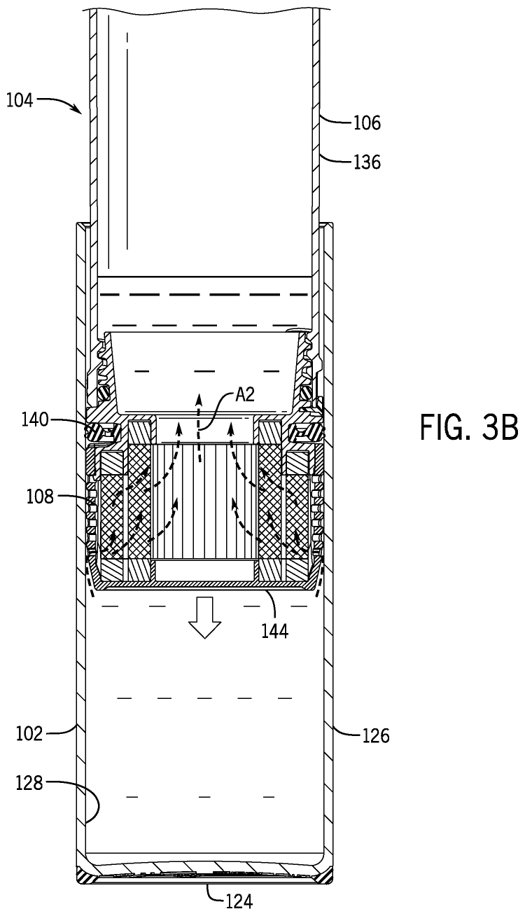

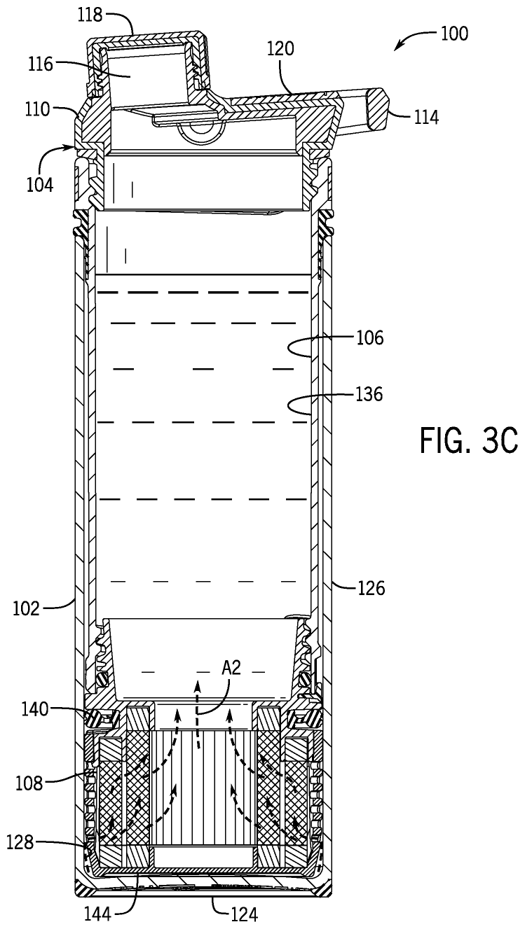

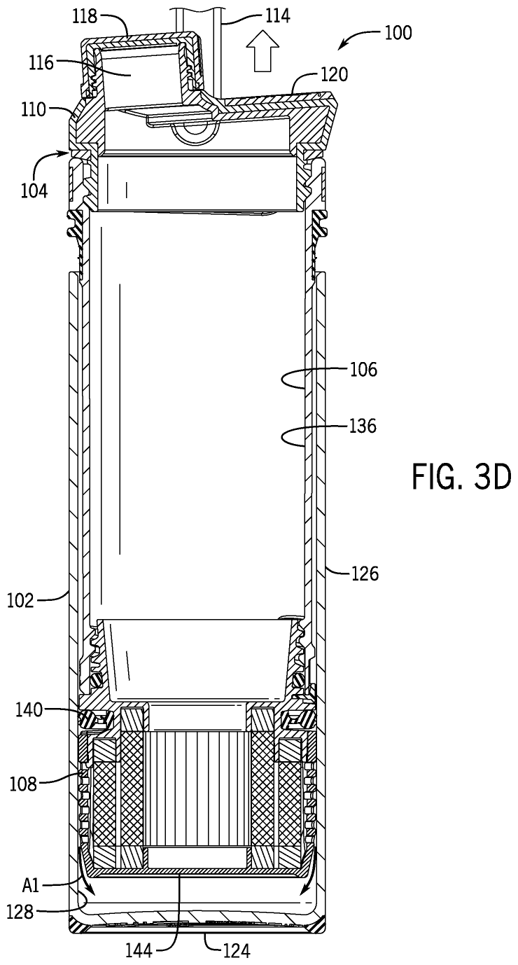

The plunging assembly 104 is configured to move like a piston relative to outer container 102, and therefore, is designed to be received within the outer container 102. Although not required, the inner sleeve 106 may have a substantially consistent cross-sectional area and/or shape along the length of inner sleeve 106. Although shown as a substantially cylindrical outer container 102, it should be appreciated that the outer container 102 may be configured to have any cross-sectional shape, so long as the inner cavity 128 of the outer container 102 and the outer wall 136 of the inner sleeve 106 are capable of nesting together. In one embodiment of the present disclosure, the inner sleeve 106 and filtration assembly 108 when nested are wholly contained within the inner cavity 128 of the outer container 102. In the illustrated embodiment, the inner cavity 128 of the outer container 102 is substantially cylindrical, and the second end 144 (e.g., the plunging end) of the plunging assembly 104 is configured to form a seal with the inner cavity 128 of the outer container 102 throughout the piston movement of the plunging assembly 104 (compare FIGS. 3A-3D).

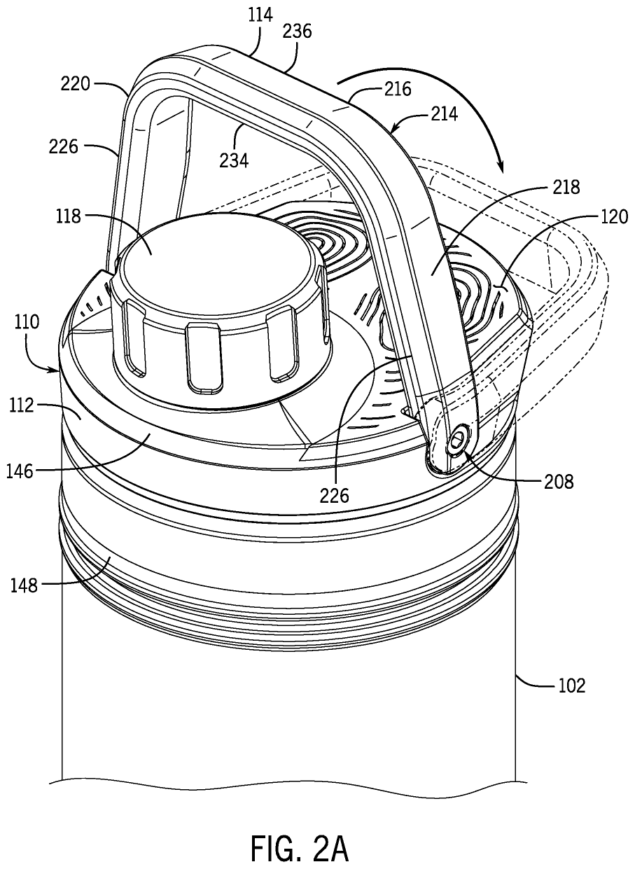

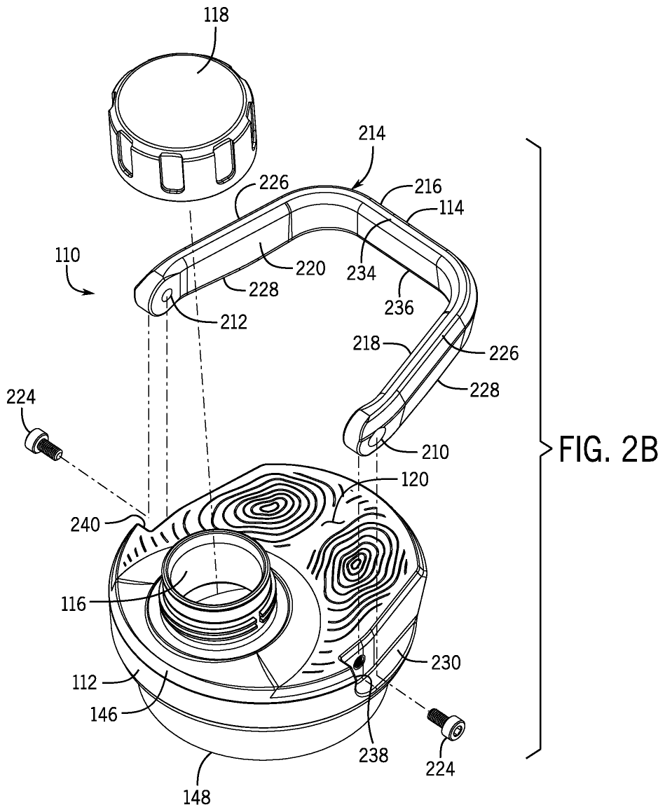

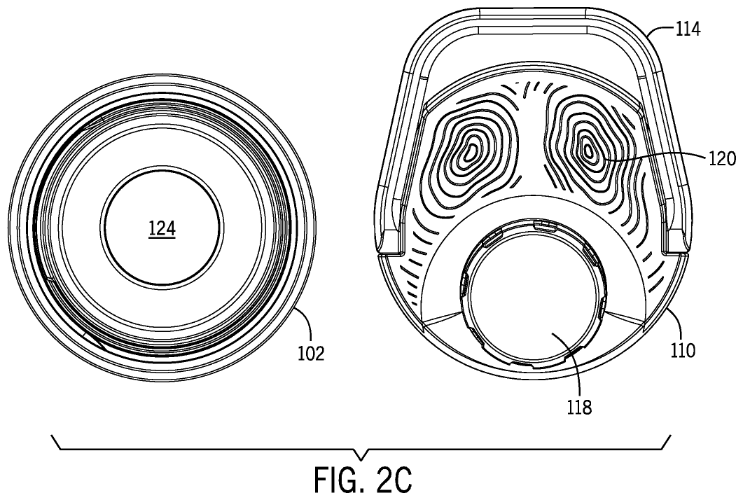

The plunging assembly 104 of the illustrated embodiment further includes a cap assembly 110 at its first end 142 (e.g., the gripping end) of the plunging assembly 104. Referring to FIGS. 1A-1C and FIGS. 2A-2C, the cap assembly 110 includes a body portion 112, an optional handle 114, and an access port or spout 116. The access port or spout 116 provides access to the inner bore 138 of the inner sleeve 106, for example, for a user to drink from or to pour from. In the illustrated embodiment, the spout 116 includes a spout cap 118.

The body portion 112 of the cap assembly 110 has a first end 150 and a second end 152 defining a cap body height. In the illustrated embodiment, the spout 116 is located at the first end 150 of the cap assembly 110, and the second end 152 of the cap assembly 110 is configured for interfacing with the first end 132 of the inner sleeve 106. In the illustrated embodiment, the cap assembly 110 and the first end 132 of the inner sleeve 106 include reciprocal threads for a screw interface. However, other suitable interfaces are also within the scope of the present disclosure.

The body portion 112 of the cap assembly 110 further defines a pressing surface 120 (see FIG. 1A) that can be used to press the plunging assembly 104 into the outer container 102. The pressing surface 120 allows for a compression force to be applied by a user to press the plunging assembly 104 into the inner cavity 128 of the outer container 102 along a longitudinal axis of the outer container 102. The second closed end 124 of the outer container 102 defines a second pressing surface upon which the compression force can the applied. For example, the second closed end 124 may be held by the user or positioned on a surface when the user presses on the first pressing surface 120. The body portion 112 or the handle 114 of the cap assembly 110 can be used to withdraw the plunging assembly 104 from the outer container 102.

As illustrated in FIGS. 2A and 2B, the handle 114 may be a pivoting handle having a pivoting assembly 208 including first and second pivoting handle attachments 210 and 212 on first and second sides of the body portion 112. The pivoting handle 114 of the illustrated embodiment moves between an extended position (see solid lines in FIG. 2A), and a retracted position (see phantom lines in FIG. 2A).

The handle 114 has a handle body 214 defining a holding portion 216 and a first arm 218 and a second arm 220. Each of the first and second arms 218 and 220 are pivotably coupled to the cap body portion 112, for example, by attachment devices, shown as fasteners 222 and 224. The handle first and second arms 218 and 220 each have a first side 226 and a second side 228 defining a handle arm width. The handle arm width is less than or equal to the cap body height.

The cap body portion 112 includes a first stop. In the illustrated embodiment, the first stop is defined by first and second lip portions 230 and 232 disposed between the first and send ends 148 and 148 of the cap body portion 112. The first and second lip portions 230 and 232 are configured to stop and support the second sides 228 of each of the first and second handle arms 218 and 220 when the handle 114 is in the retracted position.

In addition, the holding portion 216 of the handle 114 has a first side 234 and a second side 236 defining a holding portion width. The holding portion 216 may be designed and configured such that the first side 234 of the holding portion 216 and the first sides 226 of the first and second handle arms 218 and 220 create a substantially planar surface.

When the handle 114 is in the extended position, it can be used for carrying the filtration container assembly 100 or for pulling the plunging assembly 104 from the outer container 102. As seen in the illustrated embodiment of FIG. 2A, the cap body portion 112 may include a second stop, shown as surfaces 238 and 240, to interact with the first sides 226 of arms 218 and 220 to prevent the handle 114 from over-rotating beyond a predetermined angle, for example, a 90-degree or near 90-degree position, so as not to interfere with the spout 116.

When the handle 114 is in the retracted position, the pressing surface 120 of the cap body portion 112 and the second sides 228 of the handle arms 218 and 220 rest on the respective lip portions 230 and 232 of the cap body portion 112. The first sides 226 of the handle arms 218 and 220 can be used together define an enhanced (e.g., larger) pressing surface configured for a user to press the plunging assembly 104 into the inner cavity 128 of the outer container 102. In addition, the first side 234 of the handle holding portion 216 may also form part of the enhanced (e.g., larger) pressing surface configured for a user to press the plunging assembly 104 into the inner cavity 128 of the outer container 102. A large pressing surface 120 allows for ease of use for the user.

Although the first stop is illustrated as first and second lip portions 230 and 232 disposed between the first and send ends 146 and 148 of the cap body portion 112, the first stop may be designed and configured in other ways to provide support for the handle 114 so that the handle 114 may be used as part of the pressing surface. For example, the first stop may be positioned on the outer container to provide support for the handle 114. In addition, for example, the first stop may provide support to the handle holding portion 216—either in addition to or in lieu of—the handle arms 218 and 220.

Use of the filtration container assembly 100 will now be described, in greater detail with reference to FIGS. 3A-3D. As can be seen in FIGS. 3A-3D, the outer container 102 and the plunging assembly 104 are capable of nesting with one another. In that regard, the second end 144 of the plunging assembly 104 seats at the bottom of the inner cavity 128 of the outer container 102, with a sealing device 140 forming a seal with the inner wall 126 of the outer container 102. Optional guides structures may extend from the outer wall 136 of the inner sleeve 106, from the filtration assembly 108, or from the inner wall 126 of the outer container 102 to provide suitable spacing between the plunging assembly 104 and the outer container 102. A collar assembly may be included at the interface between the first end 122 of the outer container 102 and the first end 132 of the inner sleeve 106 to engage the outer container 102 and the plunging assembly 104 and to optionally form a seal therebetween, for example, to prevent liquid spillage.

Referring to FIG. 3A, when the plunging assembly 104 is removed from the outer container 102, the outer container 102 can be filled with liquid. Referring to FIGS. 3B and 3C, as the plunging assembly 104 is pressed by the user into the outer container 102, it filters liquid (e.g., such as water) from the outer container 102 as it passes through the filtration assembly 108 into the inner sleeve 106. The filtered liquid is then stored in the inner sleeve 106.

Referring to FIG. 3C, when the plunging assembly 104 is fully inserted in the outer container 102, the plunging assembly 104 in nested within the outer container 102.

Referring to FIG. 3D, after the water has been removed from the inner sleeve 106, the plunging assembly 104 may be removed from the outer container 102 so that the outer container 102 can be refilled and reused for filtering. To release the plunging assembly 104 from the outer container 102, the user simultaneously grasps the outer container 102 with one hand and the plunging assembly 104 with the other hand, releasing the coupling of the plunging assembly 104 and the outer container 102.

As can be seen in comparing FIGS. 3A and 3D, the sealing device 140 is a “floating” seal, which means it is capable of movement between first and second “up” and “down” positions. In FIG. 3D, as the plunging assembly 104 is released from the outer container 102, the sealing device 140 of the filtration assembly 108 moves to the “down” position, creating a pathway for air or liquid to release the pressure in the outer container 102, as shown by the arrows A1.

Referring now to FIG. 3A, with the plunging assembly 104 removed from the outer container 102, the outer container 102 can be filled with liquid. Referring now to FIG. 3B, after the outer container 102 has been filled, with liquid, the plunging assembly 104 can be reinserted into the outer container 102 to filter the liquid and store it in the inner bore 138 of the inner sleeve 106. As can be seen in FIG. 3B, when filtering, the sealing mechanism 140 of the filtration assembly 108 moves to the “up” position, creating a seal between the outer container 102 and the inner sleeve 106, forcing all water in the outer container 102 through the filtration assembly 108 and into the inner bore 138 of the inner sleeve 106, as shown by the arrows A2.

Although the filtration container assembly of the present disclosure is shown and described as using a floating seal for pressure release, it should be appreciated that other methods of pressure release are also within the scope of the present disclosure.

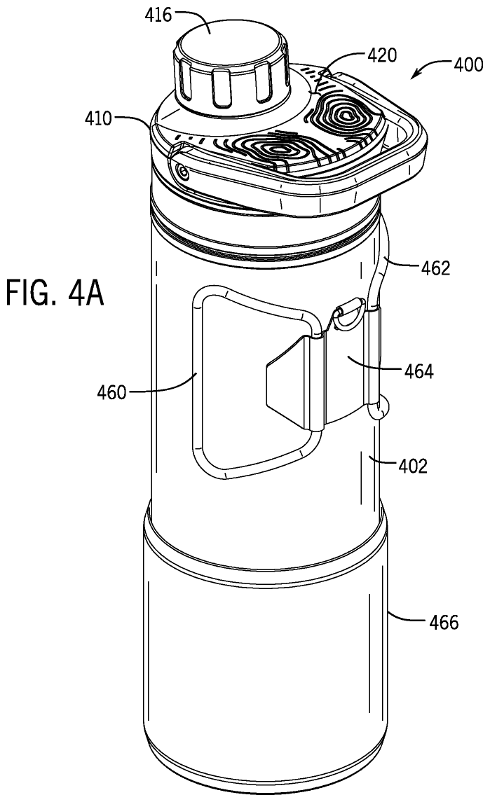

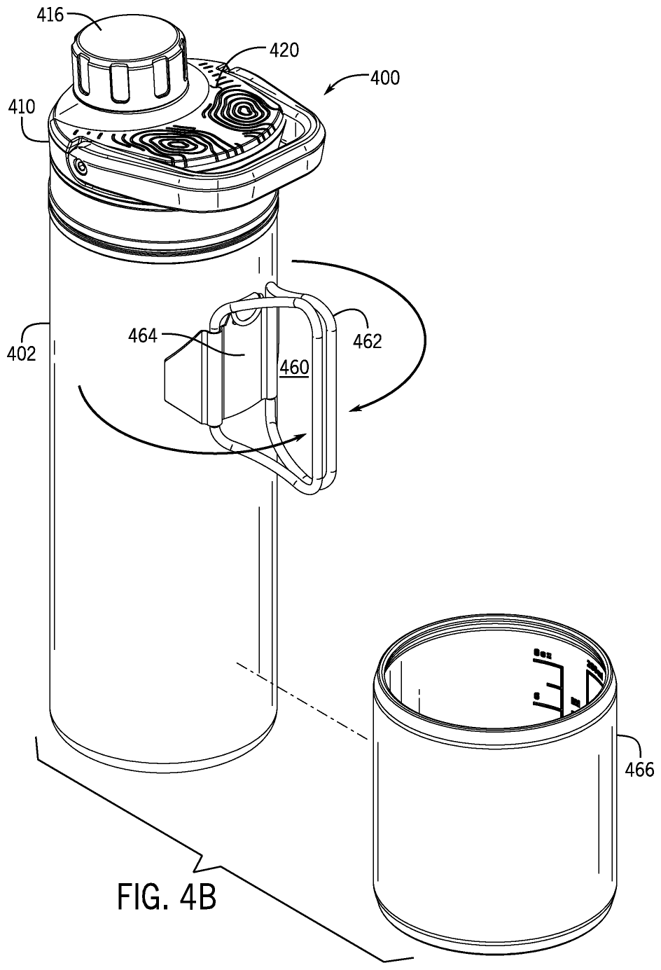

Referring to FIGS. 4A and 4B, an alternate embodiment of the filtration container assembly will now be described. Like numerals are used for the embodiment of FIGS. 4A and 4B as used in FIGS. 1A-3D, expect in the 400 series. If the outer container 402 is made of metal or another heat resistive material, it can be used for direct flame heating, for example, when boiling water when camping over a fire or on a camp stove. Movable side handles 460 and 462 (which, for example, may be made of metal or another heat resistive material) are coupled to the outer surface of the outer container 402 by an attachment bracket 406. The side handles 460 and 462 are movable between a retracted position (see FIG. 4A) such that they nest adjacent the outer surface of the outer container 402 and an extended position (see FIG. 4B) when in use. The side handles 460 and 462 can be used to move the container 402 when it is hot.

As seen in FIGS. 4A and 4B, the filtration container assemblies 100 may further include a bumper cup 464 which can be made from any suitable material such as plastic or silicon to provide a soft bottom surface to prevent damage to the outer container 402 due to bumping. The bumper cup 464 can be removable for heating the outer container 402. As seen in the illustrated embodiment of FIGS. 4B, the bumper cup 464 may include measuring lines useful, for example, for cooking when outdoors or camping.

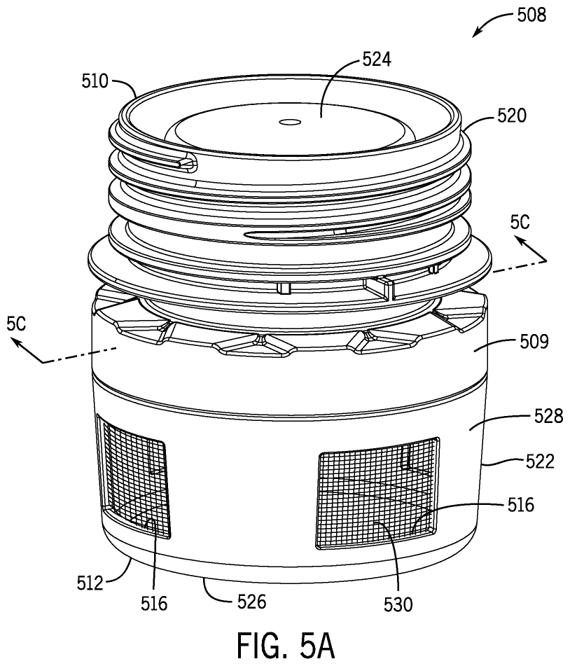

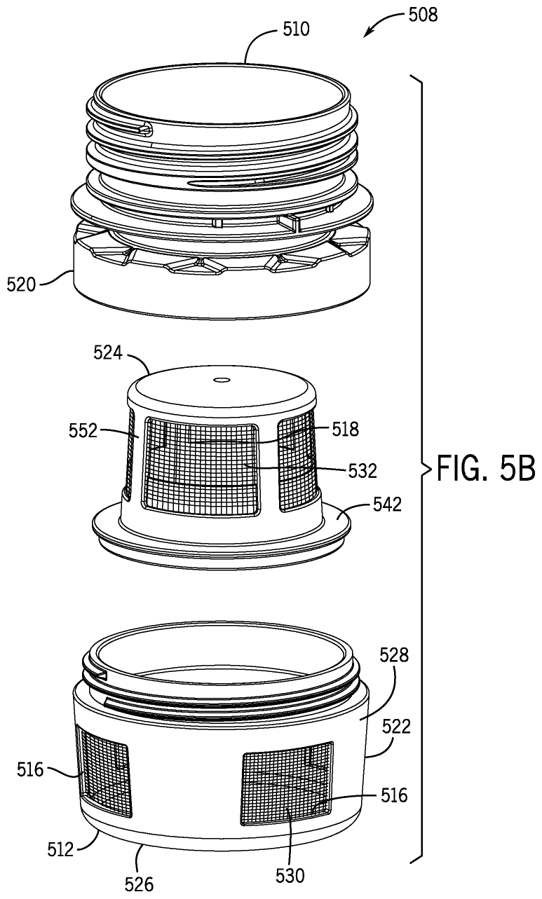

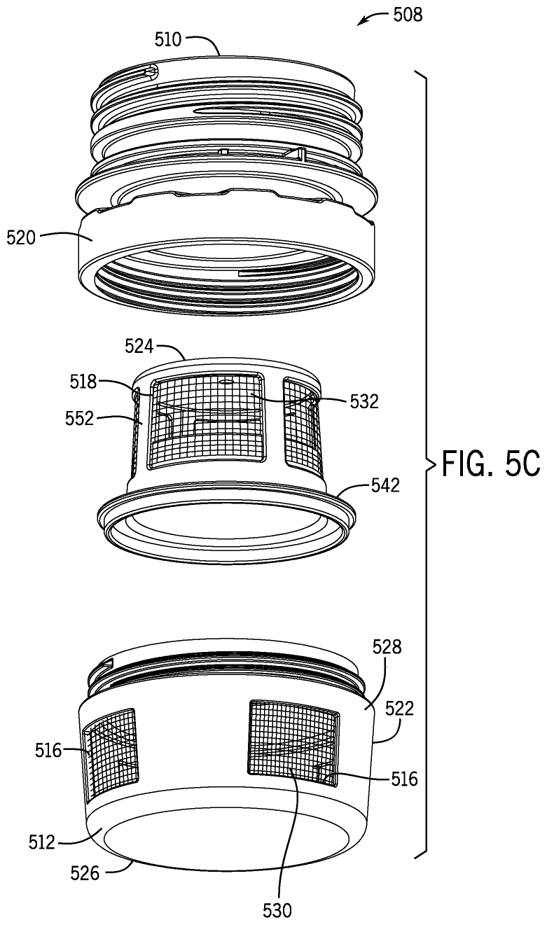

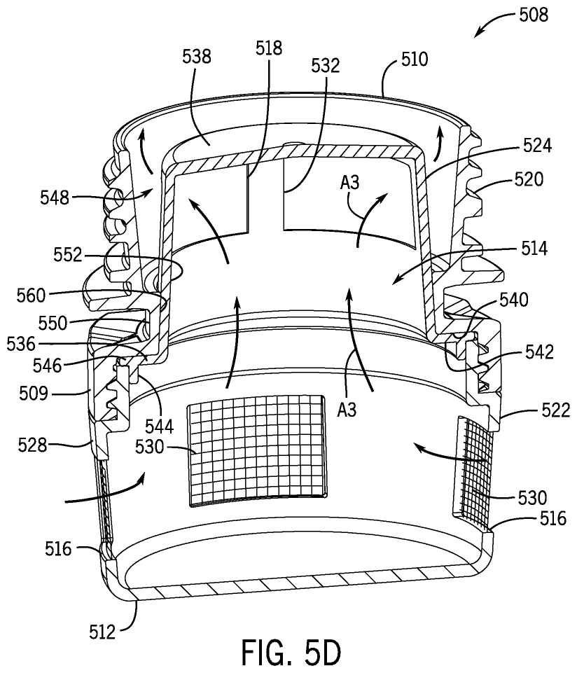

Although described as a filtration assembly 108 above, the filtration assembly may be design and configured as an extraction assembly, as seen in FIGS. 5A-5D. Instead of filtering impurities from a liquid, the extraction assembly is designed and configured to infuse liquid with soluble liquid extract of an extraction substrate, such as coffee or tea.

In the illustrated embodiment of FIGS. 5A-5D, an extraction assembly 508 is provided. In one embodiment of the present disclosure, the filtration assembly 108 of the filtration container assembly 100 (see FIGS. 1B and 1C) may be replaced with an extraction assembly 508 configured for extracting soluble flavor (e.g., such as coffee or tea) from an extraction substrate (e.g., such as coffee grounds or tea leaves) as liquid travels through the extraction assembly. Therefore, the filtration assembly 108 and the extraction assembly 508 may have similarly designed respective first ends 146 and 510 (see the first end 146 of the filtration assembly 108 in FIG. 1B and the first end 510 of the extraction assembling in FIG. 5B) to interface with the second open end 134 of the inner sleeve 106 of the filtration container assembly 100 (see the second open end 134 of the inner sleeve 106 in FIG. 1C).

Although FIGS. 3A-3D show a method of filtering liquid using the filtration assembly 108 (as opposed to extraction using the extraction assembly 508), a similar process is used when the filtration container assembly 100 is used for extraction.

Referring to FIG. 5B, the extraction assembly 508 includes a body portion 509 having a first end 510 and a second end 512. Similar to the filtration assembly 108 described above, the first end 510 of the extraction assembly 509 is couplable to the second open end 134 of the inner sleeve 106 (see the second open end 134 of the inner sleeve 106 in FIGS. 1B and 1C) to define a plunging assembly 104 of the filtration container assembly 100. With the extraction assembly 508 coupled to the plunging assembly 104 of the filtration container assembly 100, the plunging assembly 104 is an extraction plunging assembly (as opposed to a filtration plunging assembly described above with reference to FIGS. 1B and 1C).

In the illustrated embodiment, the first end 510 of the extraction assembly 508 and the second end 134 of the inner sleeve 106 include reciprocal threads for a screw interface. However, other suitable interfaces are also within the scope of the present disclosure. When the plunging assembly 104 is fully inserted in the outer container 102, the second end 512 of the extraction assembly 508 is nested within the inner cavity 128 of the outer container 102 (see the inner cavity of the outer container in FIGS. 3A-3D).

As seen in FIGS. 5B and 5D, the extraction assembly 508 includes a strainer portion 524 for straining liquid that flows through the body portion 509. The strainer portion 524 may be removably couplable to the body portion 509.

As illustrated in FIGS. 5A and 5B, the body portion 509 of the extraction assembly 508 includes a first portion 520 (shown as an upper portion) and a second portion 522 (shown as a lower portion). The first and second portions 520 and 522 are releasably couplable to each other. In the illustrated embodiment, first and second portions 520 and 522 include reciprocal threads for a screw interface. However, other suitable interfaces are also within the scope of the present disclosure.

In the illustrated embodiment, the strainer portion 524 is disposed to nest within the body portion 509 of the extraction assembly 508. For example, as shown in FIG. 5C, the strainer portion 524 can be disposed between the first portion 520 and the second portion 522. As seen in FIG. 5D, when nested, an inner chamber 514 having at least one inlet 516 and at least one outlet 518 is defined by the strainer portion 524 and the body portion 509 of the extraction assembly 508. As seen in the illustrated embodiment, the inlets 516 and outlets 518 are covered by screens or sieves to contain the extraction substrate within the inner chamber 514 of the extraction assembly 508.

In the illustrated embodiment, when nested, the strainer portion 524 can be contained between the first and second portions 520 and 522 for straining an extraction substrate (such as coffee grounds or tea leaves) (see FIG. 5D). When released, the first and second portions 520 and 522 of the body portion 509 can be detached, such that the strainer portion 524 can be removed for cleaning (see FIG. 5B).

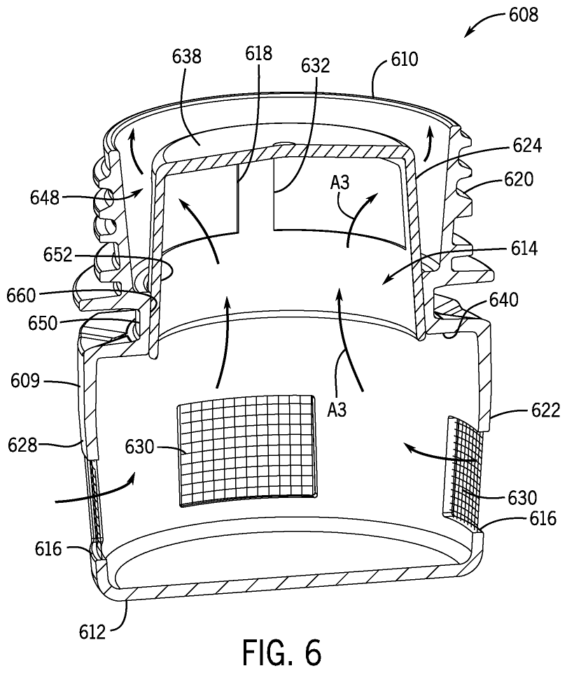

In other embodiments, the strainer portion 524 may be removably couplable to the body portion 509 by interference fit or other suitable coupling mechanism. In some examples, the body portion 509 may be configured as a single body portion with the strainer portion 524 configured to nest therewith. (See e.g., FIG. 6 described in greater detail below.)

As mentioned above, the extraction assembly 508 includes at least one fluid inlet 516, which is located at or near its second end 512, for liquid to pass from the inner cavity 128 of the outer container 102 into the extraction assembly 508 (see for example, FIGS. 3A-3D). As mentioned above, the fluid inlets 516 includes inlet sieve portions 530 that allow for liquid to freely pass from the inner cavity 128 of outer container 102 into the inner chamber 514 of the extraction assembly 508, but to contain any extraction substrate disposed within the extraction assembly 508.

The extraction assembly 508 further includes at least one fluid outlet 518 at or near its first end 510 for liquid to pass from the inner chamber 514 of the extraction assembly 508 to the inner sleeve 106 of the plunging assembly 104 (see FIGS. 3A-3D). Like the fluid inlets 516, the fluid outlets 518 also include outlet sieve portions 532 that allow for extract liquid (e.g., coffee or tea) from within the extraction assembly 508 to pass from the extraction assembly 508 to the inner sleeve 106.

To displace all the liquid contained in the inner cavity 128 of the outer container 102 through the extraction assembly 508, the second end 512 of the body portion 509 is sized and shaped to nest within the inner cavity 128 of the outer container 102 (see exemplary nesting in FIG. 3C). In that regard, the second end 512 of the extraction assembly 508 includes an end wall 526 (see FIG. 5C) and a side wall 528. The side wall 528 intersects the end wall 526, and therefore is a non-parallel surface to the end wall 526. In the illustrated embodiment, the side wall 528 is substantially normal to the end wall 526. However, other angled configurations are within the scope of the present disclosure.

The fluid inlets 516 are disposed on the side wall 528 of the extraction assembly 508 to promote increased liquid velocity, turbulence, and mixing within the extraction assembly 508. Such increased velocity and turbulence at the fluid inlets 516 of the extraction assembly 108 helps to prevent plug flow of liquid from the outer container 102 into the extraction assembly 508 so as to enhance mixing and extraction from the extraction substrate disposed in the extraction assembly 508. In some examples, assuming a constant pressing speed, velocity of the liquid flow can be further increased at the fluid inlets 516 by the tightness of the fit between the second end 512 of the extraction assembly 508 and the inner cavity 128 of the outer container 102.

In the illustrated embodiment, the fluid inlets 516 are disposed on a side wall 528 of the second portion 522 of the extraction assembly 508.

The fluid outlets 518, like the fluid inlets 516, may also be disposed on a surface that is non-parallel to the end wall 526 of the extraction assembly 508. As seen in the illustrated embodiment of FIGS. 5B-5D, the strainer portion 524 has a first end 538 and a second end 542, and a side wall 552 extending therebetween. In the illustrated embodiment, the second end 542 of the strainer portion 524 is an open end, and the first end 538 of the strainer portion 524 is a closed end. The side wall 552 is a non-parallel surface to the end wall 526. In the illustrated embodiment, the side wall 552 is angled relative to the end wall 526. However, other configurations are within the scope of the present disclosure.

The fluid outlets 518 are disposed on the side wall 552 between the first and second ends 538 and 542 of the strainer portion 524. In the illustrated embodiment, a gap 548 between the side wall 552 of the strainer portion 524 and the body portion 509 at or near the first end 510 of the extraction assembly 508 allows for fluid flow into the inner sleeve 106 of the plunging assembly 104.

Similar to the fluid inlets 516, the location of the fluid outlets 518 promote liquid turbulence and mixing within the extraction assembly 508. Such turbulence and mixing at the fluid outlets 518 of the extraction assembly 508 helps to prevent caking of the extraction substrate on the outlet sieve portions 530 to further enhance extraction.

Referring to FIG. 5D, in the illustrated embodiment, the strainer portion 524 at the second end 542 includes a flange 536 for engaging with the interface between the first and second portions 520 and 522. The flange 536 nests with an inner shoulder 540 of first portion 520 of body portion 509. The flange 536 includes a lip 544 that engages with the inner surface of the second portion 522 in an interference fit, and an outer extension 546 that is received within the interface between the first and second portions 520 and 522. In addition, the side wall 552 of the strainer portion 524 has aligned with an inner surface of a sidewall 560 of the first portion 520 of the body portion 509. In this configuration, the strainer portion 524 is contained between the first and second portions 520 and 522 of the body portion 509 and cannot be removed from the extraction assembly 508 unless the first and second portions 520 and 522 are decoupled from one another.

Other configuration for nesting the strainer portion 524 and the body portion 509 are within the scope of the present disclosure. For example, the body portion 509 may be an integrated body, and the strainer portion 524 may be disposed within the body portion 509 in an interference fit.

A cavity 550 on the outer surface of the body portion 509 may be configured to house a seal (not shown), similar to sealing device 140 shown in FIGS. 3A-3D.

In use, a user deposits coffee grounds or tea leaves or another extraction substrate inside the second portion 522 of the extraction assembly 508. The strainer portion 524 is inserted in the first portion 520 of the extraction assembly 508, and the first and second portions 520 and 522 are coupled to one another to capture the extraction substrate between the second portion 522 and the straining portion 524. Liquid is filled in the outer container 102 with a liquid to equal to or less than a fill indicator. The extraction assembly 508 is coupled to the inner sleeve 106 to define the extraction plunging assembly. The second end 512 of the extraction plunging assembly is inserted in the first open end 122 of the outer container 102 and pressed into the inner cavity 128 of the outer container 102 to produce a liquid extraction. As the liquid is displaced from the outer container 102 into the inner sleeve 106, the liquid passes through the inlet sieve portions 530 and the outlet sieve portions 532 of the extraction assembly 508, as indicated by arrows A3 in FIG. 5D.

While the extract liquid may pass into the inner sleeve 106, the extraction substrate (e.g., coffee grounds or tea leaves) remains contained within the extraction assembly 508.

Referring to FIG. 6, an alternate embodiment of the extraction assembly 608 will be described. Like numerals are used for the embodiments of FIG. 6 as used in FIGS. 5A-5D, except in the 600 series. For example, the extraction assembly 608 illustrated in FIG. 6 can include an inlet 616 that can have identical or similar features of the inlet 516 illustrated in FIG. 5D. Other numeral features of the extraction assembly 608 can be identical or similar to the like numeral features of the extraction assembly 508 in shape and function unless described to the contrary below.

As illustrated in FIG. 6, the extraction assembly 608 includes a body portion 609 and a strainer portion 624 coupled to the body portion 609. The strainer portion 624 can couple to the body portion 609 so that the strainer portion 624 is nested within the body portion 609. For example, as shown in FIG. 6, the strainer portion 624 forms an interference fit with the body portion 609 when coupled together. Similar to the extraction assembly 508 described herein, the extraction assembly 608 can couple to the inner sleeve 106 to define the extraction plunging assembly. For example, the body portion 609 and the second open end 134 of the inner sleeve 106 can include reciprocal threads for forming a screw interface.

In the illustrated embodiment, the body portion 609 includes a first end 610 at the upper end of the body portion 609, a second end 612 at the lower end of the body portion 609, and an inner wall 660 extending between the first and second ends 610, 612. The first end 610 of the body portion 609 can be open ended with the second end 612 being closed off so that the body portion 609 forms, for example, as seen in the illustrated embodiment, a cylinder, or a cylinder like shape, with a single open end. As illustrated in FIG. 6, the body portion 609 is formed from a single part. In some examples, the body portion 609 can include two or more portions that are joined (e.g., welded, bonded, glued, etc.) together so that body portion 609 functions as a single part. In other examples, the body portion 609 can be integrally formed from one or more parts.

The body portion 609 can include one or more inlets 616 formed around the perimeter of the body portion 609. Similar to the inlets 516, the inlets 616 can permit fluid to flow from the outer container 102 to within the extraction assembly 608. The inlets 616 can include an inlet sieve 630 positioned over the inlet 616 to filter the fluid that is flowing into the extraction assembly 608 from the outer container 102.

As shown in FIG. 6, the strainer portion 624 can have an end portion 638 and a side wall 652 extending outwards from the end portion 638 so that the strainer portion 624 includes an open end opposite the end portion 638. An outer surface of the side wall 652 can be configured to interface with the inner wall 660 of the body portion 609. For example, the side wall 652 can form a friction fit with inner wall 660. To couple the strainer portion 624 with the body portion 609, the strainer portion 624 can be pressed into the open end of the body portion 609 until the strainer portion 624 interfaces with the body portion 609. In some examples, the strainer portion 624 can include one or more stops which can assist with properly positioning the strainer portion 624 within the extraction assembly 608. In various examples, a sealer (e.g., an O-ring) can be coupled to an outer portion of the strainer portion 624.

The strainer portion 624 can include one or more outlets 618 formed around the perimeter of the strainer portion 624. Similar to the outlets 518, the outlets 618 can permit fluid to flow from within the extraction assembly 608 (e.g., from an inner chamber 614) to the inner sleeve 106. The outlets 618 can include an outlet sieve 632 positioned over the outlet 618 to filter the fluid that is flowing into the extraction assembly 608 from the outer container 102.

In use, a user deposits coffee grounds or tea leaves or another extraction substrate inside the inner chamber 614 of the extraction assembly 608. The strainer portion 624 is then coupled to the body portion 609 by inserting the strainer portion 624 into body portion 609. Liquid is filled in the outer container 102 with a liquid to equal to or less than a fill indicator. The extraction assembly 608 is coupled to the inner sleeve 106 to define the extraction plunging assembly. The second end 612 of the body portion 609 is inserted in the first open end 122 of the outer container 102 and pressed into the inner cavity 128 of the outer container 102 to produce a liquid extraction. As the liquid is displaced from the outer container 102 into the inner sleeve 106, the liquid passes through the inlet sieve portions 630 and the outlet sieve portions 632 of the extraction assembly 608, as indicated by arrows A3 in FIG. 6. While the extract liquid may pass into the inner sleeve 106, the extraction substrate (e.g., coffee grounds or tea leaves) remains contained within the extraction assembly 608.

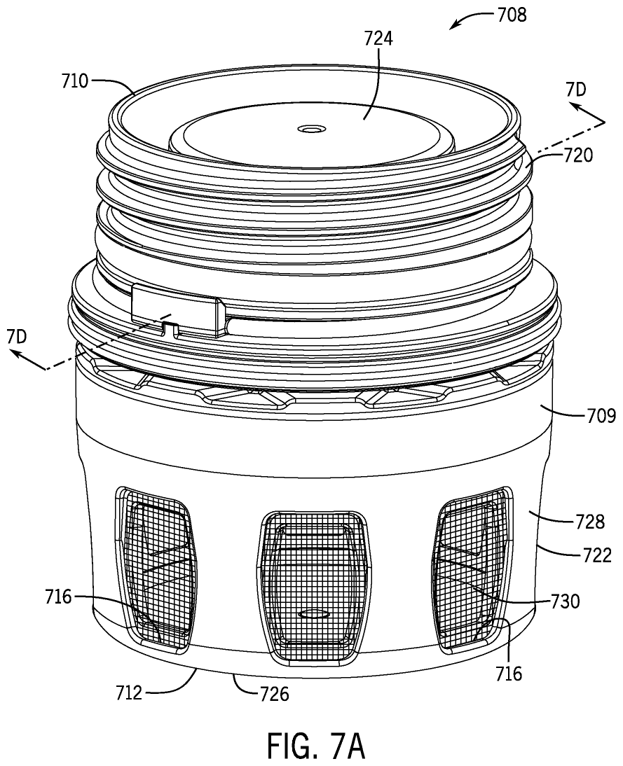

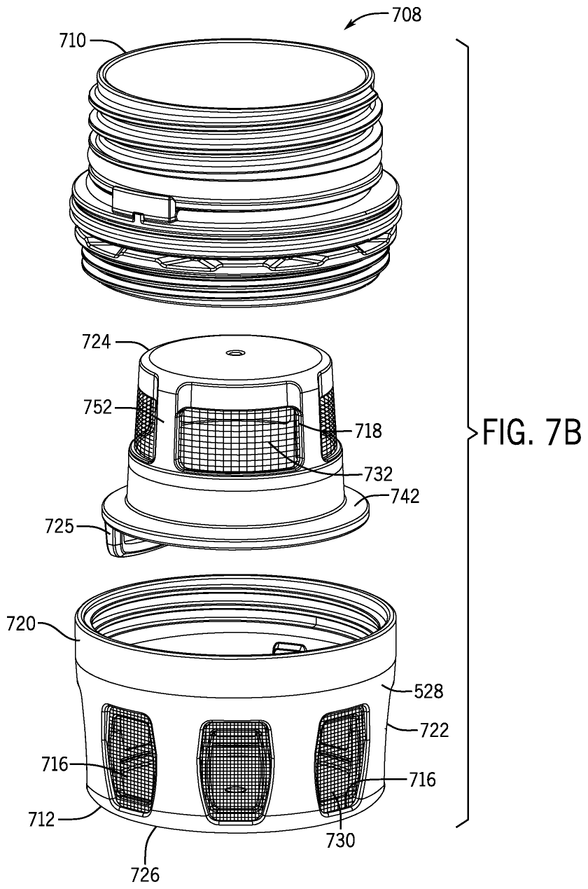

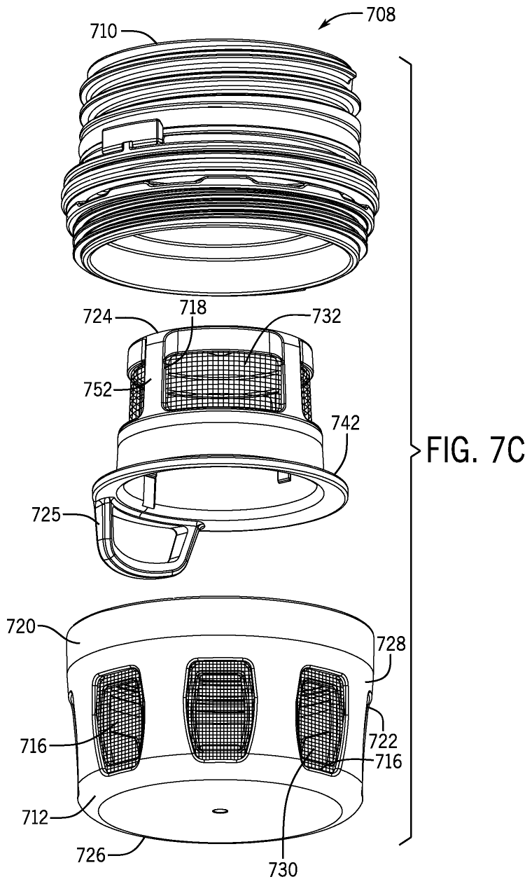

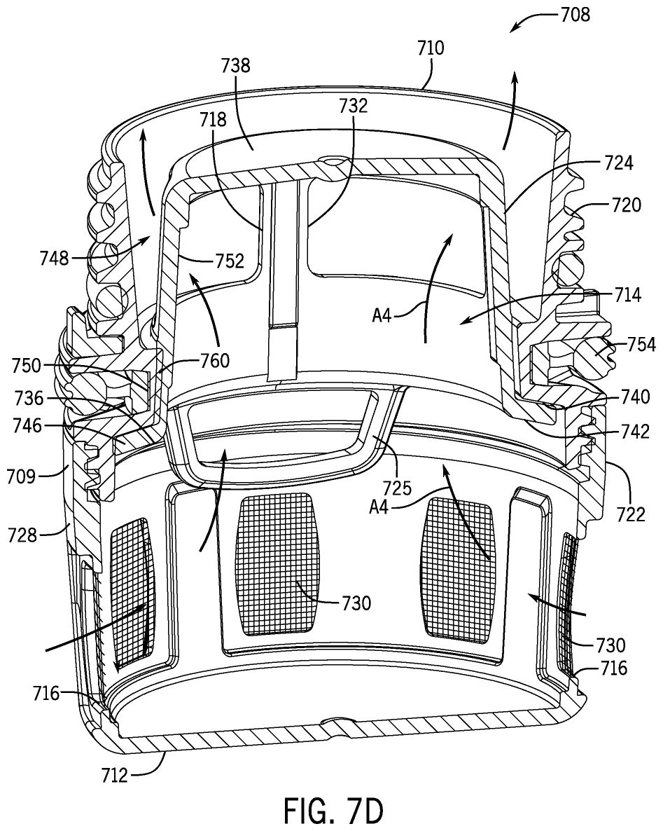

Referring to FIGS. 7A-7D, an alternate embodiment of the extraction assembly 708 will be described. Like numerals are used for the embodiments of FIGS. 7A-7D as used in FIGS. 5A-5D, except in the 700 series. For example, the extraction assembly 708 illustrated in FIGS. 7A-7D can include an inlet 716 that can have identical or similar features of the inlet 516 illustrated in FIG. 5D. Other numeral features of the extraction assembly 708 can be identical or similar to the like numeral features of the extraction assembly 508 in shape and function unless described to the contrary below.

In one embodiment of the present disclosure, the filtration assembly 108 of the filtration container assembly 100 (see FIGS. 1B and 1C) may be replaced with an extraction assembly 708 configured for extracting soluble flavor (e.g., such as coffee or tea) from an extraction substrate (e.g., such as coffee grounds or tea leaves) as liquid travels through the extraction assembly. Therefore, the filtration assembly 108 and the extraction assembly 708 may have similarly designed respective first ends 146 and 710 (see the first end 146 of the filtration assembly 108 in FIG. 1B and the first end 710 of the extraction assembling in FIG. 7B) to interface with the second open end 134 of the inner sleeve 106 of the filtration container assembly 100 (see the second open end 134 of the inner sleeve 106 in FIG. 1C).

Although FIGS. 3A-3D show a method of filtering liquid using the filtration assembly 108 (as opposed to extraction using the extraction assembly 708), a similar process is used when the filtration container assembly 100 is used for extraction.

Referring to FIG. 7A, the extraction assembly 708 includes a body portion 709 having a first end 710 and a second end 712. Similar to the filtration assembly 108 described above, the first end 710 of the extraction assembly 708 can couple to the second open end 134 of the inner sleeve 106 (see the second open end 134 of the inner sleeve 106 in FIGS. 1B and 1C) to define a plunging assembly 104 of the filtration container assembly 100. With the extraction assembly 708 coupled to the plunging assembly 104 of the filtration container assembly 100, the plunging assembly 104 is an extraction plunging assembly (as opposed to a filtration plunging assembly described above with reference to FIGS. 1B and 1C).

In the illustrated embodiment, the first end 710 of the extraction assembly 708 and the second end 134 of the inner sleeve 106 include reciprocal threads for a screw interface. However, other suitable interfaces are also within the scope of the present disclosure. When the plunging assembly 104 is fully inserted in the outer container 102, the second end 712 of the extraction assembly 708 is nested within the inner cavity 128 of the outer container 102 (see the inner cavity of the outer container in FIGS. 3A-3D).

As illustrated in FIGS. 7A-7C, the body portion 709 of the extraction assembly 708 includes a first portion 720 (shown as an upper portion) and a second portion 722 (shown as a lower portion). The first and second portions 720 and 722 are releasably couplable to each other. In the illustrated embodiment, first and second portions 720 and 722 include reciprocal threads for a screw interface. However, other suitable interfaces are also within the scope of the present disclosure.

To displace all the liquid contained in the inner cavity 128 of the outer container 102 through the extraction assembly 708, the second end 712 of the body portion 709 is sized and shaped to nest within the inner cavity 128 of the outer container 102 (see exemplary nesting in FIG. 3C). In that regard, the second end 712 of the extraction assembly 708 includes an end wall 726 (see FIG. 7C) and a side wall 728. The side wall 728 intersects the end wall 726, and therefore is a non-parallel surface to the end wall 726. In the illustrated embodiment, the side wall 728 is substantially normal to the end wall 726. However, other angled configurations are within the scope of the present disclosure.

As seen in FIGS. 7B-7D, the extraction assembly 708 includes a strainer portion 724 for straining liquid that flows through the body portion 709. The strainer portion 724 may be removably couplable to the body portion 709. In the illustrated embodiment, the strainer portion 724 is disposed to nest within the body portion 709 of the extraction assembly 708. For example, as shown in FIG. 7C, the strainer portion 724 can be disposed between the first portion 720 and the second portion 722. As seen in FIG. 7D, when nested, an inner chamber 714 having at least one inlet 716 and at least one outlet 718 is defined by the strainer portion 724 and the body portion 709 of the extraction assembly 708.

In the illustrated embodiment, when nested, the strainer portion 724 can be contained between the first and second portions 720 and 722 for straining an extraction substrate (such as coffee grounds or tea leaves) (see FIG. 7D). When released, the first and second portions 720 and 722 of the body portion 709 can be detached, such that the strainer portion 724 can be removed for cleaning (see FIG. 7B). In some examples, the strainer portion 724 may define a handle 725 to assist with detaching the strainer portion 724 from the body portion 709. For instance, after detaching the first and second portion 720 and 722 of the body portion 709 from one another, the handle 725 can be exposed, which allows for a user to grasp the handle 725 to remove the strainer portion 724 from the body portion 709.

In some embodiments, the strainer portion 724 may be removably couplable to the body portion 709 by interference fit or other suitable coupling mechanism. In some examples, the body portion 709 may be configured as a single body portion with the strainer portion 724 configured to nest therewith.

The extraction assembly 708 can include at least one fluid inlet 716, which is located at or near its second end 712, for liquid to pass from the inner cavity 128 of the outer container 102 into the extraction assembly 708 (see for example, FIGS. 3A-3D). In some examples, the fluid inlets 716 includes inlet sieve portions 730 that allow for liquid to freely pass from the inner cavity 128 of outer container 102 into the inner chamber 714 of the extraction assembly 708, but to contain any extraction substrate disposed within the extraction assembly 708.

The fluid inlets 716 can be disposed on the side wall 728 of the extraction assembly 708 to promote increased liquid velocity, turbulence, and mixing within the extraction assembly 708. Such increased velocity and turbulence at the fluid inlets 716 of the extraction assembly 108 helps to prevent plug flow of liquid from the outer container 102 into the extraction assembly 708 so as to enhance mixing and extraction from the extraction substrate disposed in the extraction assembly 708. In some examples, assuming a constant pressing speed, velocity of the liquid flow can be further increased at the fluid inlets 716 by the tightness of the fit between the second end 712 of the extraction assembly 708 and the inner cavity 128 of the outer container 102.

In some embodiments, the number of fluid inlets 716 and the size of the apertures formed on the inlet sieve portions 730 of each fluid inlet 716 can be varied as desired, which can change the characteristics of the fluid flowing through the extraction assembly 708. For instance, increasing the number of fluid inlets 716 (or the size of the fluid inlets 716) can increase the amount of the fluid that is able to flow into the inner chamber 714. As another example, decreasing the size of the apertures of the inlet sieve portions 730 can increase the pressure of the fluid flowing into the inner chamber 714.

The design of the fluid inlets 716 and inlet sieve portions 730 can be varied as desired for other purposes besides achieving the desired fluid characteristics of fluid flowing into the extraction assembly 708. For example, the fluid inlets 716 and inlet sieve portions 730 can be configured to filter out contaminants or to ensure the extraction substrate positioned within the extraction assembly 708 remains within the extraction assembly 708.

The extraction assembly 708 can further include at least one fluid outlet 718 at or near its first end 710. The fluid outlet 718 can be configured to allow liquid to pass from the inner chamber 714 of the extraction assembly 708 to the inner sleeve 106 of the plunging assembly 104 (see FIGS. 3A-3D). Like the fluid inlets 716, the fluid outlets 718 also include outlet sieve portions 732 that allow for extract liquid (e.g., coffee or tea) from within the extraction assembly 708 to pass from the extraction assembly 708 to the inner sleeve 106.

The fluid outlets 718, like the fluid inlets 716, may also be disposed on a surface that is non-parallel to the end wall 726 of the extraction assembly 708. As seen in the illustrated embodiment of FIGS. 7B-7D, the strainer portion 724 has a first end 738 and a second end 742, and a side wall 752 extending therebetween. In the illustrated embodiment, the second end 742 of the strainer portion 724 is an open end, and the first end 738 of the strainer portion 724 is a closed end. The side wall 752 is a non-parallel surface to the end wall 726. In the illustrated embodiment, the side wall 752 is angled relative to the end wall 726. However, other configurations are within the scope of the present disclosure.

The fluid outlets 718 are disposed on the side wall 752 between the first and second ends 738 and 742 of the strainer portion 724. In the illustrated embodiment, a gap 748 between the side wall 752 of the strainer portion 724 and the body portion 709 at or near the first end 710 of the extraction assembly 708 allows for fluid flow into the inner sleeve 106 of the plunging assembly 104.

Similar to the fluid inlets 716, the location of the fluid outlets 718 promote liquid turbulence and mixing within the extraction assembly 708. Such turbulence and mixing at the fluid outlets 718 of the extraction assembly 708 helps to prevent caking of the extraction substrate on the outlet sieve portions 730 to further enhance extraction. In some embodiments, the design of the fluid outlets 718 and outlet sieve portions 732 can be varied as desired. For example, the number of fluid outlets 718 and the size of the apertures formed on the outlet sieve portions 732 of each fluid outlet 718 can be varied to change the characteristics of the fluid flowing out of the extraction assembly 708.

Referring to FIG. 7D, in the illustrated embodiment, the strainer portion 724 at the second end 742 includes a flange 736 for engaging with the interface between the first and second portions 720 and 722. The flange 736 nests with an inner shoulder 740 of first portion 720 of body portion 709. The flange 736 can include an outer extension 746 that is received within the interface between the first and second portions 720 and 722 and can engage the inner surface of the first and/or second portion 720 and 722 to form an interference fit. In addition, the side wall 752 of the strainer portion 724 has aligned with an inner surface of a sidewall 760 of the first portion 720 of the body portion 709. In this configuration, the strainer portion 724 is contained between the first and second portions 720 and 722 of the body portion 709 and cannot be removed from the extraction assembly 708 unless the first and second portions 720 and 722 are decoupled from one another.

Other configuration for nesting the strainer portion 724 and the body portion 709 are within the scope of the present disclosure. For example, the body portion 709 may be an integrated body, and the strainer portion 724 may be disposed within the body portion 709 in an interference fit.

A cavity 750 on the outer surface of the body portion 709 may be configured to house a seal 754, similar to sealing device 140 shown in FIGS. 3A-3D.

In use, a user deposits coffee grounds or tea leaves or another extraction substrate inside the second portion 722 of the extraction assembly 708. The strainer portion 724 is inserted in the first portion 720 of the extraction assembly 708, and the first and second portions 720 and 722 are coupled to one another to capture the extraction substrate between the second portion 722 and the straining portion 724. Liquid is filled in the outer container 102 with a liquid to equal to or less than a fill indicator. The extraction assembly 708 is coupled to the inner sleeve 106 to define the extraction plunging assembly. The second end 712 of the extraction plunging assembly is inserted in the first open end 122 of the outer container 102 and pressed into the inner cavity 128 of the outer container 102 to produce a liquid extraction. As the liquid is displaced from the outer container 102 into the inner sleeve 106, the liquid passes through the inlet sieve portions 730 and the outlet sieve portions 732 of the extraction assembly 708, as indicated by arrows A4 in FIG. 7D. While the extract liquid may pass into the inner sleeve 106, the extraction substrate (e.g., coffee grounds or tea leaves) remains contained within the extraction assembly 708.

In accordance with embodiments of the present disclosure, an exemplary use of the filtration container assembly 100 will now be described. Referring to FIGS. 4A and 4B, water used for coffee or tea may be measured using the bumper cup 464, placed in the outer container 402, and heated over an open flame.

Either before or after the water is heated to a temperature suitable for making coffee or tea, the water may be filtered for impurities using a filtration container assembly 100 having an attached filtration assembly 108 (see FIGS. 3A-3D). After filtering the water, coffee or tea can be made by replacing the filtration assembly 108 in the filtration container assembly 100 with the extraction assembly 508.

The hot, filtered water is disposed in the outer container 402, and the plunging assembly 104 is pushed into the outer container 402 to displace the water from the outer container 402 through the extraction assembly 508 (or the extraction assemblies 608, 708) to produce a coffee or tea beverage disposed in the inner sleeve 106. The beverage may be poured into the outer container 408, and the extraction assembly 508 (or the extraction assemblies 608, 708) may be removed from the inner sleeve 106 and cleaned for its next use. In pouring the coffee or team from the plunging assembly 104 into the outer container 408, any liquid remaining inside the extraction device 508 (or the extraction assemblies 608, 708) will also pour out, while the coffee grounds or tea leaves remaining inside the extraction assembly 508 (or the extraction assemblies 608, 708). Then, any desired beverage additives—like cream or sugar—can be added to the beverage in the outer container 408.

Other technical features may be readily apparent to one skilled in the art from the following figures, descriptions, and claims. While illustrative embodiments have been illustrated and described, it will be appreciated that various changes can be made therein without departing from the spirit and scope of the disclosure.

What is claimed is:

1. A container assembly, the assembly comprising:
an outer container having a first open end and a second closed end and defining an inner cavity; and
a plunging assembly configured to be received within the outer container, the plunging assembly having a first end and a second end, wherein the plunging assembly includes an inner sleeve having a first end and a second end and a wall defining an inner bore, and wherein the plunging assembly includes an extraction assembly having a body having a first end and a second end and a side wall extending for at least a portion of the distance between the first and second ends of the body, wherein the first end of the body is coupled to the inner sleeve at or near the second end of the inner sleeve, and wherein the body includes a first sieve portion, and wherein the extraction assembly further includes a strainer having a second sieve portion, wherein the strainer is removably couplable to the body.

2. The assembly of claim 1, wherein the body includes first and second body portions.

3. The assembly of claim 2, wherein the first and second body portions are removably couplable to one another.

4. The assembly of claim 3, wherein the strainer is fixed relative to the body when the first and second body portions are coupled to one another, and wherein the strainer is removable from the body when the first and second body portions are uncoupled.

5. The assembly of claim 3, wherein the strainer includes a flange configured to be fixedly received between the first and second body portions when the first and second body portions are coupled to one another.

6. The assembly of claim 1, wherein the first sieve portion is disposed on the side wall of the body.

7. The assembly of claim 1, wherein the strainer includes a first end and a second end and a side wall extending for at least a portion of the distance therebetween, wherein the second sieve portion is disposed within the side wall of the strainer.

8. The assembly of claim 1, wherein the first end of the extraction assembly is mechanically coupled to the inner sleeve at or near the second end of the inner sleeve.

9. The assembly of claim 1, wherein the second end of the extraction assembly is outside the inner bore of the inner sleeve.

10. The assembly of claim 1, wherein the container assembly further includes a device for releasing pressure from the inner cavity of the outer container when the plunging assembly is received within the inner cavity of the outer container.

11. The assembly of claim 1, wherein the plunging assembly is configured to displace a liquid contained in the outer container from the inner cavity of the outer container to the inner bore of the inner sleeve of the plunging assembly.

12. The assembly of claim 1, wherein the extraction assembly is configured to include an extraction substrate.

13. The assembly of claim 1, further comprising a lid.

14. The assembly of claim 13, wherein the lid is removable from the plunging assembly.

15. The assembly of claim 14, wherein the lid includes an access port to the inner bore of the inner sleeve.

16. An extraction assembly for a container assembly, the container assembly including an outer container having a first open end and a second closed end and defining an inner cavity, and a plunging assembly configured to be received within the outer container, the plunging assembly having a first end and a second end, wherein the plunging assembly includes an inner sleeve having a first end and a second end and a wall defining an inner bore, the extraction assembly comprising:
a body having a first end and a second end and a side wall extending for at least a portion of the distance between the first and second ends of the body, wherein the first end of the body is coupled to the inner sleeve at or near the second end of the inner sleeve, and wherein the body includes a first sieve portion; and
a strainer having a second sieve portion, wherein the strainer is removably couplable to the body.

17. A method of infusing a liquid using a container assembly, the method comprising:
obtaining a filtration container assembly including an outer container having a first open end and a second closed end and defining an inner cavity and a plunging assembly configured to be received within the outer container, the plunging assembly having a first end and a second end, wherein the plunging assembly includes an inner sleeve having a first end and a second end and a wall defining an inner bore, and wherein the plunging assembly includes an extraction assembly having a body having a first end and a second end and a side wall extending for at least a portion of the distance between the first and second ends of the body, wherein the first end of the body is coupled to the inner sleeve at or near the second end of the inner sleeve, and wherein the body includes a first sieve portion, and wherein the extraction assembly further includes a strainer having a second sieve portion, wherein the strainer is removably couplable to the body;
filling the outer container with a liquid to equal to or less than a fill indicator;
filling the extraction assembly with an extraction substrate;
coupling the extraction assembly to the inner sleeve to define the extraction plunging assembly;
inserting the second end of the extraction plunging assembly into the first open end of the outer container; and
pressing the extraction plunging assembly into the inner cavity of the outer container to produce a liquid extraction.

18. The method of claim 17, further comprising, prior to using the extraction plunging assembly, obtaining a filtration container assembly including an outer container having a first open end and a second closed end and defining an inner cavity and a plunging assembly configured to be received within the outer container, the plunging assembly having a first end and a second end, wherein the plunging assembly includes an inner sleeve having a first end and a second end and a wall defining an inner bore, and wherein the plunging assembly includes a filtration assembly having a body having a first end and a second end and a side wall extending for at least a portion of the distance between the first and second ends of the body, wherein the first end of the body is coupled to the inner sleeve at or near the second end of the inner sleeve;
filling the outer container with a liquid to equal to or less than a fill indicator;
coupling the filtration assembly to the inner sleeve to define the filtration plunging assembly;
inserting the second end of the filtration plunging assembly into the first open end of the outer container; and
pressing the filtration plunging assembly into the inner cavity of the outer container to produce a filtered liquid.

19. The method of claim 18, further comprising pouring the filtered liquid into the outer container.

20. The method of claim 17, further comprising heating the liquid in the outer container.
